(19) United States
(12) Patent Application Publication
(10) Pub. No.: US 2025/0193637 A1
(43) Pub. Date: Jun. 12, 2025

(54) ENERGIZER-AIDED POSITIONING OF AMBIENT DEVICES IN AN ELECTRONIC SHELF LABEL (ESL) SYSTEM

(71) Applicant: QUALCOMM Incorporated, San Diego, CA (US)

(72) Inventors: Varun Amar Reddy, San Diego, CA (US); Sony Akkarakaran, Poway, CA (US); Chengjin Zhang, San Diego, CA (US)

(21) Appl. No.: 18/531,549

(22) Filed: Dec. 6, 2023

(51) Int. Cl. H04W 4/02; G09F 3/20; H04B 17/318

(52) U.S. Cl. CPC H04W 4/023; G09F 3/204; G09F 3/208; H04B 17/318

(57) ABSTRACT

This disclosure provides systems, methods, and devices for Electronic Shelf Label (ESL) systems that support positioning of ambient devices. In a first aspect, a method includes: configuring a first subset of devices to transmit energizing radio waves for an ambient device in a vicinity of the first subset; receiving, from a second subset of devices, positioning data relating to signal transmissions received by the second subset from the ambient device based on the energizing radio waves from the first subset; comparing the positioning data with ground truth data correlating devices with known locations; identifying, based on the comparing, at least one matching device for which the ground truth data matches the positioning data; and determining a position of the ambient device based on a corresponding known location of the at least one matching device. Other aspects and features are also claimed and described.

### TECHNICAL FIELD

Aspects of the present disclosure relate generally to ambient Internet of Things (IoT) devices, and more particularly, to methods and systems for positioning ambient IoT devices in an indoor environment using an infrastructure of an electronic shelf label (ESL) system deployed within the environment.

### INTRODUCTION

In general, retail stores use paper labels to display information about products displayed on shelves, such as prices, discount rates, unit costs, origins, or the like. Using such paper labels for the price display has limitations. For example, when there are changes in product information or locations on shelves, the retailer must generate new paper labels and discard old ones. This raises costs for maintenance in both supplies and employee labor. Further, in environmental terms, replacing the labels wastes raw materials such as paper, which adversely affects the protection of the environment. Still further, humans are prone to make mistakes, such as mislabeling a shelf or product or forgetting to take down temporary price changes on certain shelving, which results in shopper frustration.

Electronic shelf label (ESL) devices are electronic devices for displaying price or other relevant information for items on retail store shelves, which may be used in place of paper labels. ESL devices may be attached to a front edge of retail shelving and display a variety of information using display devices, such as Liquid Crystal Displays (LCD). Whenever the information about a product or the location of a product is changed, the ESL device may be programmed with new product information. Thus, the same electronic shelf label can be repeatedly used. The individual ESL devices or nodes of an ESL system may be equipped with Bluetooth Low Energy (BLE) radios that can be used to estimate a position of a BLE-enabled device based on the known locations of nearby ESL devices within an indoor environment, such as a retail environment associated with a retail store or distribution warehouse. Fingerprinting has been widely considered as a potential solution for position estimation of low-powered or battery-less ambient Internet of Things (IoT) devices in such environments. However, traditional fingerprinting techniques used for indoor positioning suffer from numerous drawbacks, such a lack of accuracy in the estimated position due to signal interference.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Electronic shelf label (ESL) devices of an ESL system deployed within an environment (such as a retail environment associated with a retail store or a distribution warehouse) may be used to provide different kinds of information and services to various users of the ESL system (such as shoppers or store workers). For example, ESL devices operating on a wireless network as part of the ESL system may support indoor positioning services to identify the respective locations of ESL devices within the environment (e.g., on shelves of gondolas located within a retail store). The ESL devices and other devices or components of the ESL system may represent different nodes of an infrastructure of the ESL system (or “ESL infrastructure”). As another example, the ESL system (with the aid of various ESL infrastructure devices/nodes) may support position location services to estimate or determine a position of objects or devices, such as a mobile device of a user or other wireless devices, within the environment.

As still another example, the ESL system may be used to provide positioning techniques for determining the position of an ambient device, such as an ambient Internet of Things (IoT) tag placed on an object of interest, such as a product, inventory item, or other asset in the environment, e.g., for purposes of asset tracking, inventory monitoring, and/or supply chain management in a retail environment. In some embodiments, an energizer subsystem of the ESL infrastructure may be used to facilitate and improve the positioning of ambient devices within the environment. The energizer subsystem may include, for example, multiple energizers corresponding to the various gondolas within the environment. In some implementations, an energizer may be deployed on a shelf of each gondola within the environment. Each energizer may be a specialized wireless device similar to an access point that primarily serves to broadcast energizing radio waves for supplying ambient power to nearby IoT tags or other low-powered ambient devices within the environment.

In some embodiments, the transmissions from the energizer devices may be used to enrich positioning measurements collected during a training or surveying phase of a fingerprinting process for various nodes or devices of the ESL infrastructure at known locations within the environment. Examples of such ESL infrastructure nodes include, but are not limited to, ESL devices, access points, and energizers. The positioning measurements recorded for each ESL infrastructure node may serve as a ground truth for signal reception characteristics associated with a known location of that node within the environment. Additional ground truth data, including a set of energizer transmission parameters (such as a range of transmission powers, time slots, beams, and channels), may be recorded during the training/surveying phase for each known location based on one or more energizer transmissions detected by a corresponding ESL infrastructure node at that location. The recorded ground truth data may be compared with positioning data relating to energizer-based transmissions made by an ambient device during a testing or positioning phase of the fingerprinting process to determine a position of the ambient device within the environment.

For example, an ambient device (such as an IoT tag) powered by energizing waveforms from an energizer during the testing/positioning phase may transmit beacon signals that are based on the energizing waveform and therefore, indicative of the transmission parameters associated with the energizer's transmissions. The beacon signals transmitted by the ambient device may be received and measured by one or more ESL infrastructure nodes (e.g., one or more ESL devices and/or access points) in a vicinity of the ambient device. The ESL infrastructure node(s) may then send positioning data including measurements of the ambient device's beacon signals and corresponding transmission parameters to a server of the ESL system. The server may compare the positioning data with the previously recorded ground truth data to identify at least one device of the ESL infrastructure for which the signal characteristics and energizer parameters match those of the beacon signals from the ambient device. The server may then determine a position of the ambient device within the environment based on at least one known location corresponding to the at least one device.

Example embodiments provide systems and methods for positioning ambient IoT devices within an environment using an energizer subsystem of an ESL infrastructure deployed within an environment.

In one aspect of the disclosure, a method includes: configuring, by a server, a first subset of devices to transmit energizing radio waves for an ambient device in a vicinity of the first subset; receiving, by the server from a second subset of devices, positioning data relating to signal transmissions received by the second subset from the ambient device based on the energizing radio waves from the first subset; comparing, by the server, the positioning data with ground truth data correlating devices with known locations; identifying, by the server based on the comparing, at least one matching device for which the ground truth data matches the positioning data; and determining, by the server, a position of the ambient device based on a corresponding known location of the at least one matching device.

In an additional aspect of the disclosure, an apparatus includes a memory storing processor-readable code and at least one processor coupled to the memory. The at least one processor is configured to execute the processor-readable code to cause the at least one processor to perform operations including: configuring a first subset of devices to transmit energizing radio waves for an ambient device in a vicinity of the first subset; receiving, from a second subset of devices, positioning data relating to signal transmissions received by the second subset from the ambient device based on the energizing radio waves from the first subset; comparing the positioning data with ground truth data correlating devices with known locations; identifying, based on the comparing, at least one matching device for which the ground truth data matches the positioning data; and determining a position of the ambient device based on a corresponding known location of the at least one matching device.

In an additional aspect of the disclosure, a non-transitory computer-readable medium stores instructions that, when executed by a processor, cause the processor to perform operations. The operations include: configuring a first subset of devices to transmit energizing radio waves for an ambient device in a vicinity of the first subset; receiving, from a second subset of devices, positioning data relating to signal transmissions received by the second subset from the ambient device based on the energizing radio waves from the first subset; comparing the positioning data with ground truth data correlating devices with known locations; identifying, based on the comparing, at least one matching device for which the ground truth data matches the positioning data; and determining a position of the ambient device based on a corresponding known location of the at least one matching device.

In an additional aspect of the disclosure, an electronic shelf label (ESL) system comprises: a first subset of devices; a second subset of devices; and a server comprising a memory and at least one processor coupled to the memory. The at least one processor is configured to perform operations including: configuring the first subset of devices to transmit energizing radio waves for an ambient device in a vicinity of the first subset; receiving, from the second subset of devices, positioning data relating to signal transmissions received by the second subset from the ambient device based on the energizing radio waves from the first subset; comparing the positioning data with ground truth data correlating devices with known locations; identifying, based on the comparing, at least one matching device for which the ground truth data matches the positioning data; and determining a position of the ambient device based on a corresponding known location of the at least one matching device.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

Devices, networks, and systems may be configured to communicate via one or more portions of the electromagnetic spectrum. The present disclosure describes certain aspects with reference to certain communications technologies, such as Bluetooth or Wi-Fi. However, the description is not intended to be limited to a specific technology or application, and one or more aspects described with reference to one technology may be understood to be applicable to another technology. Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus, and methods described herein may be applied to other communications systems and applications than the particular examples provided.

For example, the described implementations may be implemented in any device, system, or network that is capable of transmitting and receiving RF signals according to any of the wireless communication standards, including any of the IEEE 802.11 standards, the IEEE 802.15.1 Bluetooth® standards, Bluetooth low energy (BLE), code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, 5G New Radio (5G NR), 6G, or other known signals that are used to communicate within a wireless, cellular, or internet of things (IoT) network, such as a system utilizing 3G, 4G 5G, or 6G technology, or further implementations thereof.

In various implementations, the techniques and apparatus may be used in wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably and may refer to a collection of devices capable of communicating with each other through one or more communications techniques.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, or packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.).

Implementations may range from chip-level or modular components to non-modular, non-chip-level implementations and further to aggregated, distributed, or original equipment manufacturer (OEM) devices or systems incorporating one or more described aspects. In some settings, devices incorporating described aspects and features may also include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, or constitutions.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a device is described as containing components A, B, or C, the device may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1A is a block diagram illustrating a perspective view of an example Electronic Shelf Label (ESL) system within a retail environment according to some embodiments of this disclosure.

FIG. 1B is a block diagram of an overhead view of the ESL system of FIG. 1A according to some embodiments of the disclosure.

FIG. 1C is a diagram illustrating an example ESL device in the ESL system of FIGS. 1A and 1B according to some embodiments of the disclosure.

FIG. 2A is a perspective view of a gondola including shelves with ESL devices for displaying information regarding products available for selection by a user within a retail environment according to some embodiments of the disclosure.

FIG. 2B is a top-down view of an example product region corresponding to an aisle between two gondolas within the retail environment of FIG. 2A according to some embodiments of the disclosure.

FIG. 3 is a timing diagram illustrating a time division multiplexing scheme for scheduling communications between different devices of an ESL infrastructure according to some embodiments of the disclosure.

FIG. 4 is a block diagram illustrating an example configuration of an ESL device according to some embodiments of this disclosure.

FIG. 5 is a block diagram illustrating an example configuration of an ambient device according to some embodiments of this disclosure.

FIG. 6 is a block diagram of an example server for positioning ambient devices within an environment using an energizer subsystem of an ESL infrastructure deployed in the environment according to some embodiments of this disclosure.

FIG. 7 is a flow chart of an example method for positioning ambient devices within an environment using an energizer subsystem of an ESL infrastructure deployed in the environment according to some embodiments of this disclosure.

Like reference numbers and designations in the various drawings indicate like elements.

### DETAILED DESCRIPTION

The present disclosure provides systems, apparatus, methods, and computer-readable media that support indoor positioning of various devices or objects within an indoor environment, such as a retail environment associated with a retail store or distribution warehouse. In some embodiments, an Electronic Shelf Label (ESL) system may be deployed within the environment for purposes of monitoring assets (e.g., product locations), tracking inventory, and providing indoor positioning and navigation services for users (e.g., customers or store employees) within the environment. An infrastructure of the ESL system may include a plurality of devices or nodes deployed at known locations throughout the environment. For example, the ESL infrastructure may include a dense deployment of ESL devices on various shelves across multiple gondolas throughout the environment. The ESL devices on the shelves of each gondola may be used to display pricing and other relevant information regarding products placed on each shelf. The known locations of the ESL infrastructure devices may represent ground truth locations on a map of the environment with a known layout of its distinctive features and landmarks, such as the specific arrangement of products, shelves, gondolas, and other fixtures.

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

In some implementations, each gondola may also include an energizer device that serves as a power source for supplying ambient power to the ESL devices on the shelves of the gondola via a wired or wireless connection. Such an energizer may be a specialized wireless device installed on a shelf of the gondola that broadcasts energizing waveforms to be harvested as usable energy by ambient devices (such as ambient Internet of Things (IoT) tags) in a vicinity of the energizer. The energizer itself may be powered by a battery or other power source. The ESL devices, energizers, other devices (such as access points) of the ESL system may represent different nodes of an infrastructure of the ESL system (or “ESL infrastructure”).

Particular implementations of the subject matter described in this disclosure may be implemented to realize one or more of the following potential advantages or benefits. In some aspects, the present disclosure provides techniques for wireless communication systems that may be particularly beneficial for asset tracking, inventory monitoring, and/or supply chain management in retail environments, such as retail stores and distribution warehouses. For example, the disclosed techniques may be used to determine the position of an ambient device, such as an ambient Internet of Things (IoT) tag placed on an object of interest, such as a product, inventory item, or other asset in the environment, e.g., for purposes of asset tracking, inventory monitoring, and/or supply chain management in a retail environment. In some embodiments, an energizer subsystem of the ESL infrastructure may be used to facilitate and improve the positioning of ambient devices within the environment. The energizer subsystem may include, for example, multiple energizers corresponding to the various gondolas within the environment. In some implementations, an energizer may be deployed on a shelf of each gondola within the environment, as described above. Each energizer may be a specialized wireless device similar to an access point that primarily serves to broadcast energizing radio waves for supplying ambient power to nearby IoT tags or other low-powered ambient devices within the environment.

In some embodiments, the transmissions from the energizer devices may be used to enrich positioning measurements collected during a training or surveying phase of a fingerprinting process for various nodes or devices of the ESL infrastructure at known locations within the environment. Examples of such ESL infrastructure nodes include, but are not limited to, ESL devices, access points, and energizers. The positioning measurements recorded for each ESL infrastructure node may serve as a ground truth for signal reception characteristics associated with a known location of that node within the environment. Additional ground truth data, including a set of energizer transmission parameters (such as a range of transmission powers, time slots, beams, and channels), may be recorded during the training/surveying phase for each known location based on one or more energizer transmissions detected by a corresponding ESL infrastructure node at that location. The recorded ground truth data may be compared with positioning data relating to energizer-based transmissions made by an ambient device during a testing or positioning phase of the fingerprinting process to determine a position of the ambient device within the environment.

For example, an ambient device (such as an IoT tag or other device) powered by energizing waveforms from an energizer during the testing/positioning phase may transmit beacon signals that are based on the energizing waveform and therefore, indicative of the transmission parameters associated with the energizer's transmissions. In some embodiments, such ambient devices may include no internal power supply for operating certain circuitry or functionality within the device and rely on the energizing waveform for operating certain circuitry or functionality.

The beacon signals transmitted by the ambient device may be received and measured by one or more ESL infrastructure nodes (e.g., one or more ESL devices and/or access points) in a vicinity of the ambient device. The ESL infrastructure node(s) may then send positioning data including measurements of the ambient device's beacon signals and corresponding transmission parameters to a server of the ESL system. The positioning data for the ambient device may represent a “fingerprint” of the device's signaling characteristics at a particular location within the environment. The server may compare the positioning data with the previously recorded ground truth data to identify at least one device of the ESL infrastructure for which the ground truth data matches the positioning data relating to the beacon signal transmissions from the ambient device. The server may then determine a position of the ambient device within the environment based on the known location corresponding to the at least one device.

By using dedicated devices or nodes of an ESL infrastructure deployed within the environment, the disclosed fingerprinting techniques are more scalable than conventional fingerprinting approaches that rely solely on survey-based information. Also, by coordinating the transmission and measurement of positioning signals exchanged between different ESL infrastructure nodes and ambient devices, the positioning measurements acquired using the disclosed techniques may account for the impact of signal interference relative to those acquired using conventional techniques.

The terms “ambient IoT device” (or “ambient IoT tag”) and “ambient device” are used interchangeably herein to refer broadly and inclusively to any battery-less wireless device that relies on harvesting ambient energy from one or more external sources (such as radio waves, solar energy/light, thermal energy, mechanical vibration, etc.) to power its internal electric components. Such an ambient device may have limited energy storage capacity with only a capacitor to temporarily store the harvested energy before being used to power one or more electrical components necessary to perform a particular function or operation, such as sending or receiving beacon signals to and from nearby devices of an ESL infrastructure deployed within an environment. In some implementations, the ambient device may be in the form of a low-cost, flexible tag or sticker that can be placed on an object to be tracked or monitored in the environment, as described above.

The terms “fingerprinting” and “location fingerprinting” are used interchangeably herein to refer broadly and inclusively to the process of using past or previously acquired measurements of positioning signals as a basis for estimating a position of a device, such as an ambient device, within an environment. Fingerprinting generally involves recording positioning measurements that serve as a ground truth for signal reception characteristics associated with a known location within the environment. Such ground-truth measurements may provide a reference point that can later be used for positioning a target device within the environment based on measurements received from the target device that match the previous ground-truth measurements.

A “vicinity” of a device in this context may include, for example, a certain radius or area surrounding the device's current position in which other devices (e.g., one or more ESL infrastructure nodes) within the environment may be located. In some implementations, the size of the radius or surrounding area may be predefined. Alternatively, the size of area may vary depending on the wireless signaling capabilities or particular wireless technology supported by the device. For example, devices in the “vicinity” of an ambient device may be limited to those located within a wireless signaling range of the ambient device and thus, sufficiently close enough to exchange wireless signals with the ambient device.

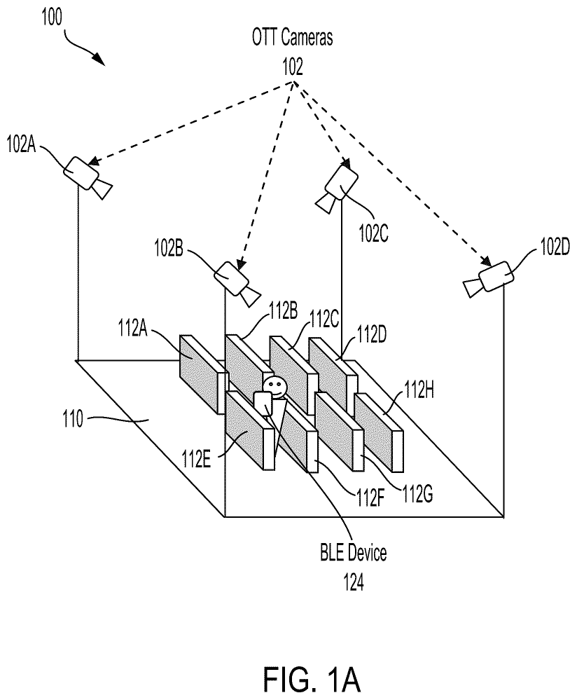

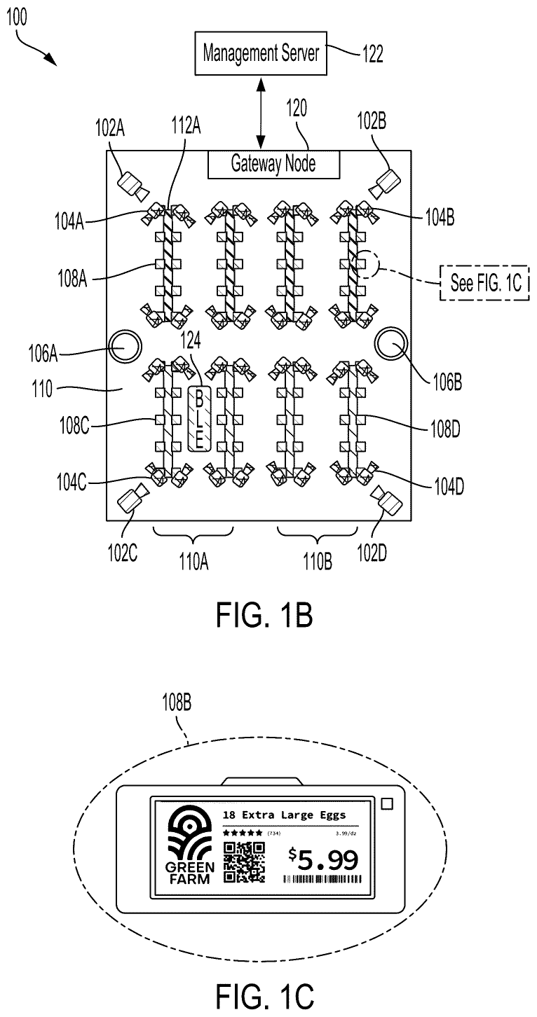

The terms “environment” and “retail environment” are used interchangeably herein to refer broadly and inclusively to any physical space or layout (e.g., within a physical “brick-and-mortar” retail store or distribution warehouse) where a business operates (e.g., to provide products or services to customers). An example of such an environment will be described in further detail below with reference to FIGS. 1A and 1B.

FIG. 1A is a block diagram illustrating a perspective view of an example ESL system 100 within a retail environment according to some embodiments of this disclosure. As shown in FIG. 1A, the ESL system 100 may be deployed across multiple aisles of gondolas 112A-112H within a retail environment 110. The retail environment 110 may include, for example, a retail floor space of a retail store. As will be described in further detail below, each of the gondolas 112A-112H may include one or more shelves to which a plurality of ESL devices are attached. The ESL devices may be used to display pricing and/or other information related to products located on the shelves. Each of the ESL devices may include one or more wireless radios for transmitting and receiving information over a wireless network. Such radios may support any of various wireless communication standards and technologies. Examples of such technologies include, but are not limited to, Wi-Fi, Bluetooth, Bluetooth Low Energy (BLE), 5G NR, ultra-wideband (UWB), and other RF technologies.

As will be described in further detail below with respect to FIG. 1B, cameras may be installed on or near the shelves at the ends of the gondolas 112A-112H to capture different views of the aisles and/or other pathways in the areas surrounding the gondolas 112A-112H. Additionally, over-the-top (OTT) cameras 102A-102D (or “OTT cameras 102” collectively) may be positioned at different overhead locations throughout the retail store to capture larger regions of the retail environment 110. In some implementations, the OTT cameras 102 may be part of a separate surveillance system of the retail store used for security and monitoring purposes.

In some embodiments, images and/or video captured by the OTT cameras 102 and/or those captured by the shelf cameras on the gondolas 112A-112H may be utilized as visual channel state information (CSI) to reduce, if not resolve, any errors or ambiguities detected in the position of a BLE device 124 within the retail environment 110. The BLE device 124 may be, for example, a mobile device of a user (e.g., a customer or employee of the retail store). Alternatively, the BLE device 124 may be an ambient IoT tag placed on an object (e.g., an inventory item, product, or other asset) to be tracked within the retail environment 110, as will be described in further detail below. In some implementations, the BLE device 124 may be equipped with a BLE radio for receiving low power beacon signals transmitted by the ESL devices and other devices of the ESL infrastructure (such as one or more energizers) attached to shelves of the gondolas 112A-112H.

In some implementations, radio frequency (RF) measurements of signal transmissions received from the BLE device 124 by various devices of the ESL infrastructure located in a vicinity of the BLE device 124 may be provided to a management server of the ESL system 100 for determining a position of the BLE device 124 within the retail environment 110, as will be described in further detail below. In a case where the BLE device 124 is an ambient IoT device/tag, the signal transmissions made by the BLE device 124 may be based on energizing radio waves received from one or more energizer devices of the ESL infrastructure deployed within the environment (e.g., installed on one or more shelves of gondola 112E and/or 112F near the BLE device 124, as shown in FIG. 1A).

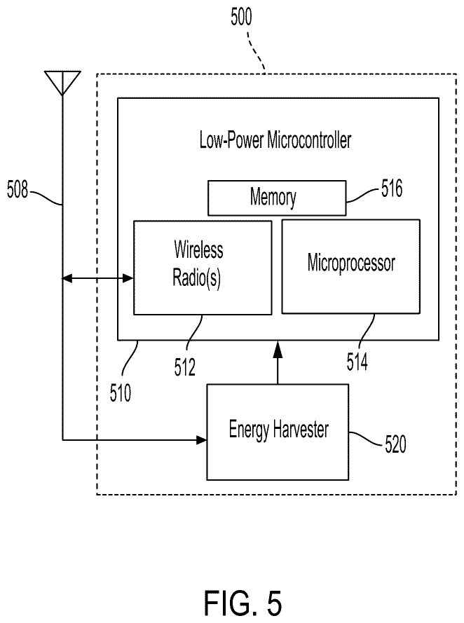

FIG. 1B is a block diagram of an overhead view of the ESL system 100 of FIG. 1A according to some embodiments of the disclosure. As shown in FIG. 1B, the ESL system 100 may further include a management server 122 that is integrated with or coupled to a gateway node 120. The management server 122 may include at least one processor coupled to a memory or a computer-readable medium, which stores computer program code executable by the at least one processor. The execution of the computer program code by the at least one processor may cause the management server 122 to perform operations related to the management and control of ESL devices 108A-108D, access points (APs) 106A and 106B, the gateway node 120, and/or other components of the ESL system 100. In some embodiments, the management server 122 may perform operations for determining a position of the BLE device 124 (e.g., implemented as an ambient IoT device) in the environment 110 using energizers and other devices associated with the infrastructure of the ESL system 100, as will be described in further detail below with reference to FIGS. 5-7.

The gateway node 120 may communicate with access point (AP) 106A and access point (AP) 106B. Although only two APs are shown in the example of FIG. 1B, fewer or more APs may be included in the ESL system 100. The APs 106A and 106B may communicate through a first communication network, either wired or wireless, with the gateway node 120. The APs 106A and 106B may also communicate through a second communication network with the ESL devices 108A-108D. In some embodiments, the first and second communication networks may be different wireless networks. For example, the first communication network (e.g., between the AP 106A and the gateway node 120) may be a Wi-Fi network, and the second communication network (e.g., between the AP 106A and the ESL device 108A) may be a Bluetooth network. In some implementations, the APs 106A and 106B (and other components of the ESL system 100) may be part of a wireless infrastructure of the retail environment 110 that supports one or more wireless technologies (e.g., Wi-Fi, Bluetooth, BLE, and/or UWB).

In some embodiments, each of the APs 106A and 106B may communicate with a subset of the ESL devices 108A-108D located in a geographic area assigned to that AP, e.g., based on a location of the AP relative to each ESL device and/or a signal coverage area of the AP. For example, the retail environment 110 may be divided into two equally-sized geographic areas that each cover approximately half of the total retail environment 110. The AP 106A may be assigned to a geographic area 110A, and the AP 106B may be assigned to a geographic area 110B. Accordingly, the AP 106A may communicate with ESL device 108A and ESL device 108B located in the geographic area 110A, and the AP 106B may communicate with ESL device 108C and ESL device 108D located in the geographic area 110B.

Bluetooth technology provides a secure way to connect and exchange information between electronic devices, such as smartphones, other cellular phones, headphones, earbuds, smartwatches, laptops, wearables, and/or shelf labels. Bluetooth communications may include establishing wireless personal area networks (PANs) (also referred to as “ad hoc” or “peer-to-peer” networks). These ad hoc networks are commonly called “piconets.” Each device may belong to multiple piconets. Multiple interconnected piconets may be called scatternets. A scatternet may be formed when a member of a first piconet elects to participate in a second piconet. In the example of FIG. 1B, the ESL devices 108A and 108C may be in a piconet with the AP 106A.

Because many of the services offered over Bluetooth can expose private data or allow the connecting party to control the connected device, Bluetooth networks may have devices first establish a “trust relationship” before they are allowed to communicate private data to one another. This trust relationship may be established using a process referred to as “pairing,” in which a bond is formed between two devices. This bond enables the devices to communicate with each other in the future without further authentication. Thus, the ESL device 108A in FIG. 1B may be bonded in such a manner to the AP 106A. The pairing process may be triggered automatically each time the device is powered on or moved within a certain distance of another Bluetooth device. Pairing information relating to current and previously established pairings may be stored in a paired device list (PDL) in the memory of the Bluetooth device, such as the ESL device 108A and/or the AP 106A. This pairing information may include a name field, an address field, a link key field, and other similar fields (such as “profile” type) useful for authenticating the device or establishing a Bluetooth communication link. The pairing information may allow the ESL device 108A to reconnect to the AP 106A automatically when, for example, power loss causes the ESL system 100 to reset.

A Bluetooth “profile” describes general behaviors through which Bluetooth-enabled devices communicate with other Bluetooth devices. For example, the hands free profile (HFP) describes how a Bluetooth device (such as a smartphone) may place and receive calls for another Bluetooth device, and the Advanced Audio Distribution Profile (A2DP) describes how stereo-quality audio may be streamed from a first Bluetooth device (such as a smartphone) to another Bluetooth device (such as an earbud). The ESL devices 108A-108D may be configured with an ESL Profile compliant with, for example, the Electronic Shelf Label Profile Specification v1.0 dated Mar. 28, 2023, which is incorporated by reference herein. The ESL Profile may specify how the AP 106A may use one or more ESL Services exposed by the ESL device 108A.

In some embodiments, the management server 122 may include or be coupled to a database that stores and manages information regarding inventory (e.g., products) and other assets (the ESL devices 108A-108D and other components of the ESL system 100) in the retail environment 110. The management server 122 may include or be coupled to a database that stores and manages a variety of information used in the operation of a retail store or distribution warehouse. Such information may include product information regarding products displayed in the store as well as the location, layout, and other relevant information associated with each component of the ESL system 100 (including each of the ESL devices 108A-108D and the APs 106A and 106B).

In some implementations, the database may be part of an Enterprise Resource Planning (ERP) inventory management system associated with the retail environment 110. Such an inventory management system may be implemented either separately from or as a part of the ESL system 100.

In some embodiments, the database may be used to store and maintain information pertaining to ambient devices (such as their capabilities, last known locations, and other relevant information pertaining each device). For example, the database may be used to store a device identifier (ID) for each ambient device (or IoT tag) in association with information pertaining to a corresponding product or item of inventory on which the IoT tag is placed for monitoring and tracking purposes. The device ID stored for each ambient IoT tag in this example may later be used to identify the tag and associated product or item based on identification information received from the tag by one or more devices of the ESL infrastructure. In some embodiments, the identification information may be included in a beacon message transmitted by the tag after receiving energizing radio waves from one or more energizer devices, which the tag harvests as energy for powering its internal electrical components. An example configuration of such an ambient IoT tag or device including energy harvesting circuitry and other components will be described in further detail below with reference to FIG. 5.

In some embodiments, the management server 122 may generate and transmit command messages including commands directed to different devices of the ESL infrastructure (e.g., APs 106A and 106B, ESL devices 108A-108D, and/or energizer devices installed on the gondolas 112A-112H) via one or more wireless networks, as described above. The command messages may be used by the management server 122 to configure selected devices of the ESL infrastructure to carry out various functions in the ESL system 100, such as the synchronization, updating, and alteration of product information displayed on the ESL devices 108A-108D. The management server 122 may obtain the product information from a product database provided for the ESL devices 108A-108D. That is, the management server 122 may be provided with a database that stores identification information relating to the ESL devices 108A-108D in connection with product information to be displayed on a corresponding one of the ESL devices 108A-108D.

A command message created by the management server 122 (e.g., a product-information change message or a management-information acquisition message) can be transferred to the gateway node 120 as part of a packet suitable for a communication scheme used with the gateway node 120. Furthermore, the management server 122 may receive a reception acknowledgement message sent from the gateway node 120 using the communication scheme. In some cases, the acknowledgement message may be first converted into a message format suitable for reception by the management server 122 before being transferred by the gateway node 120.

Although only one gateway node 120 is shown in FIG. 1B, the ESL system 100 may include several such gateway nodes communicating with the management server 122. Each gateway node 120 analyzes data received from the management server 122, confirms the presence or absence of a message or data to be sent to one or more of the ESL devices 108A-108D, and then sends the confirmed message or data to the appropriate ESL device. For example, the gateway node 120 may configure a message, which is to be sent to the ESL device 108A, into a packet according to a communication scheme and send the configured packet to the ESL device 108A by commanding the AP 106A to transmit the packet. Furthermore, the gateway node 120 may transfer a reception acknowledgement message received from the ESL device 108A through the AP 106A to the management server 122.

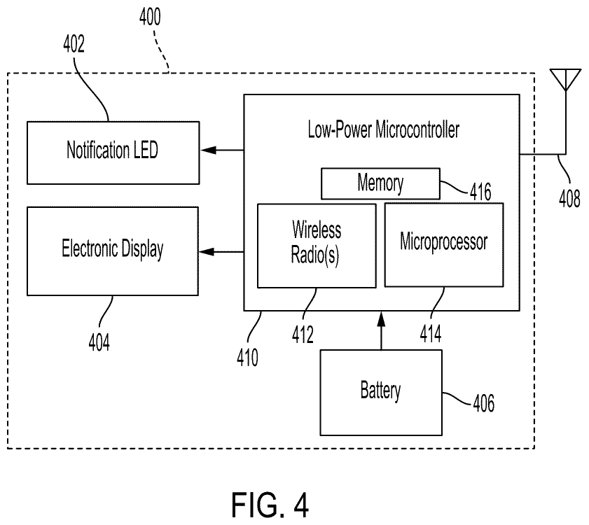

In some embodiments, each of the ESL infrastructure devices (such as the ESL devices 108A-108D and the energizers) may have a configuration that includes a memory, a microprocessor, and other components (such as one or more wireless radios) for performing various operations, including signal transmission and reception as configured by the management server 122 for fingerprinting and positioning. An example of such an ESL device configuration will be described in further detail below with reference to FIG. 4.

In some embodiments, each of the ESL devices 108A-108D may also include a display, such as a Liquid Crystal Display (LCD) or electronic ink (e-ink) display, for displaying data concerning products located on a shelf to which the corresponding ESL device is attached. The information displayed by each of the ESL devices 108A-108D may be received from the gateway node 120. The ESL devices 108A-108D may change price information or be activated or inactivated while communicating with the gateway node 120. A store manager may send the management server 122 a command concerning the synchronization between a product and a specified ESL device and/or a command for the correction of information regarding a product assigned to the particular ESL device. An example of the ESL device 108B is shown in FIG. 1C with a display device for displaying product information, such as a product description, a product image, a product price, a product barcode, a product rating, a product Stock Keeping Unit (SKU), and/or a product link (e.g., a URL or QR code).

In some embodiments, a video monitoring system may be included as part of the ESL system 100 or used to augment the capabilities of the ESL system 100. As described above, cameras may be installed on or near the shelves at the ends of the gondolas 112A-112H to capture different views of the aisles between the gondolas 112A-112H and/or other pathways in the areas surrounding the gondolas 112A-112H. For example, shelf cameras 104A-104D may be positioned with a field of view capturing one or more shelves of one or more of the gondolas 112A-112H. The shelf cameras 104A-104D may be used to assist in tracking stock levels and/or identifying items picked by users while in the environment. Also, as described above, OTT cameras 102A-102D may be positioned with a field of view capturing large regions of the retail environment 110. The visual information (e.g., images and/or video) captured by the OTT cameras 102A-102D and the shelf cameras 104A-104D may be transmitted to the management server 122 for processing.

In some implementations, the management server 122 may apply object recognition models or algorithms to the image frames received from the OTT cameras 102A-102D and/or shelf cameras 104A-104D to determine a presence of, or count of, people and objects (including products and ESL devices on shelves) located in the field of view of a respective camera. For example, the OTT cameras 102A-102D and/or shelf cameras 104A-104D may be used to support the determination of the locations of the ESL devices 108A-108D and/or other devices or nodes (e.g., APs 106A and 106B) of the ESL infrastructure within the retail environment 110.

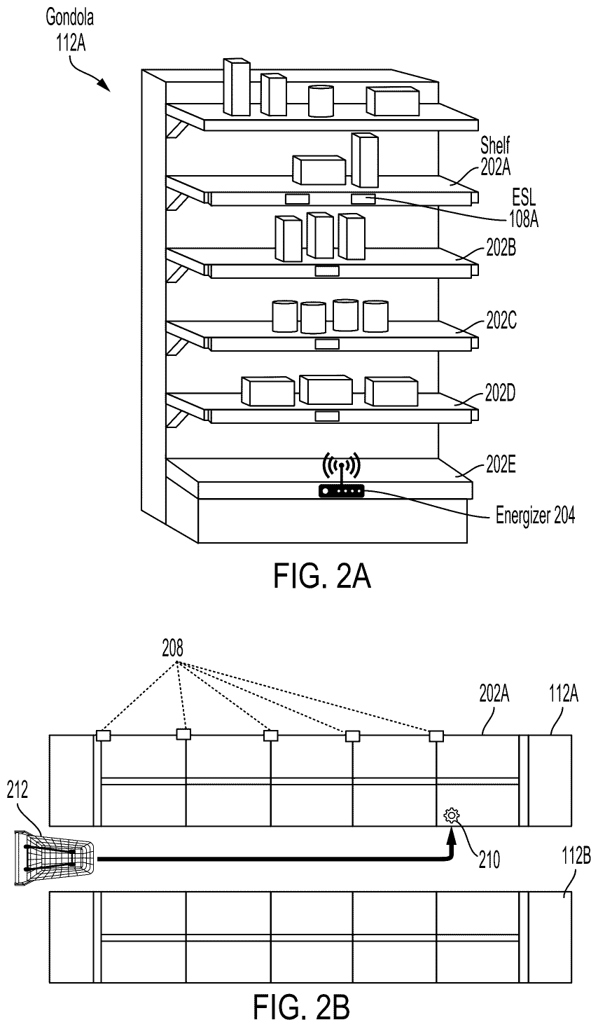

As described above, the retail environment 110 associated with the ESL system 100 may include multiple ESL devices (including ESL devices 108A-108D) organized on shelves of gondolas located throughout the environment 110. One example illustration of such a gondola with an arrangement of ESL devices is shown in FIG. 2A.

FIG. 2A is a perspective view of a gondola 112A with ESL devices arranged on various shelves according to some embodiments of the disclosure. The gondola 112A may include multiple shelves 202A-202E at different vertical levels from a floor. ESL devices and other devices of the ESL infrastructure may be attached to the shelves 202A-202E. For example, ESL device 108A may be attached to shelf 202A to display information regarding products stocked on shelf 202A in a vicinity of the ESL device 108A.

Furthermore, an energizer 204 may be installed on shelf 202E to supply power to the ESL devices on the gondola 112A and/or ambient devices (e.g., IoT tags attached to products) located in a vicinity of the energizer 204. The energizer 204 may be a wireless device including one or more wireless radios that support communication over different wireless networks, similar to the APs 106A and 106B, as described above. In some implementations, the energizer 204 may be a dual-mode battery-powered device that includes a Bluetooth wireless radio and a radio frequency identification (RFID) or near-field communication (NFC) reader.

Although the energizer 204 may have wireless capabilities similar to that of the APs 106A or 106B, the energizer 204 may be a dedicated device that primarily serves to energize or supply ambient power through energizing radio waves transmitted to any nearby ambient devices within the environment. In some implementations, the energizer 204 may be part of an energizer subsystem of the ESL infrastructure with multiple energizer devices deployed across different gondolas (e.g., gondolas 112A-112H of FIG. 1A) throughout the environment. Each gondola may include, for example, one or more energizer devices that may be configured by the management server 122 to transmit radio waves for energizing an ambient device in a vicinity of the energizer(s). For example, the ambient device may include energy harvesting circuitry that converts ambient energy from the radio waves transmitted by the energizer 204 into electrical energy that can be used to power internal electrical components (e.g., a microprocessor and/or a wireless radio) required to perform one or more operations. Such operation(s) may include, for example, operations for data processing and/or data transmissions relating to the disclosed energizer-aided fingerprinting and positioning techniques, as will be described in further detail below with respect to FIGS. 5-7.

The ESL devices, such as ESL device 108A, may provide information regarding products and/or position information to assist with location-based services for a user (e.g., a shopper or store worker) within the environment. FIG. 2B is a top-down view of a retail environment with ESL devices accessible to a user according to some embodiments of the disclosure. As shown in FIG. 2B, gondola 112A may include a dense deployment of ESL devices 208 (including the ESL device 108A of FIG. 2A) in which adjacent ESL devices may be uniformly spaced along the shelf 202A. Additional ESL devices may be similarly positioned along other shelves of gondola 112A and along the shelves of gondola 112B.

A user pushing a shopping cart 212 through the aisle between the gondolas 112A and 112B may use the ESL devices 208 to determine the location of a particular product. For example, a wireless device associated with the shopping cart 212 and/or a mobile device (e.g., BLE device 124 of FIGS. 1A and 1B) of the user may use RF measurements of radio signals broadcasted by the ESL devices 208 (and/or other nearby ESL devices) to estimate a current location of the shopping cart 212 (and user) within the environment and guide the user to a location 210 of a desired product on the appropriate shelf of gondola 112A.

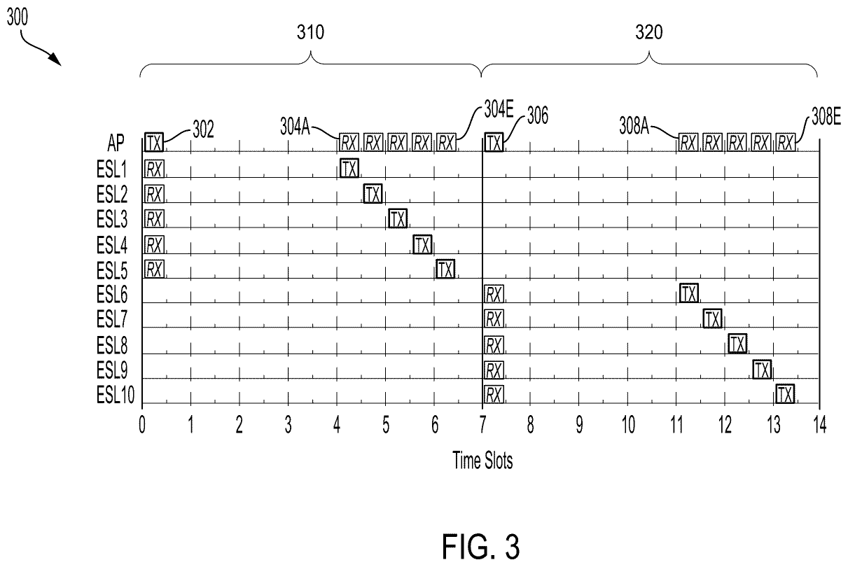

In some embodiments, communication between an AP and the ESL devices of an ESL system, such as between the AP 106A and ESL devices 108A-108D of the ESL system 100 of FIG. 1B, may be performed according to a Time Division Multiple Access (TDMA) scheme, as illustrated in FIG. 3. FIG. 3 is a timing diagram illustrating a time division multiplexing scheme 300 for scheduling communications between different nodes of an ESL infrastructure according to some embodiments of the disclosure. The nodes in this example may include an AP and various ESL devices of an ESL system deployed at known locations within an environment (e.g., retail environment 110 of FIGS. 1A and 1B, as described above). As shown in FIG. 3, an AP and each ESL device of the ESL system may be allocated one of various time periods corresponding to different time slots for transmitting or receiving information. It should be appreciated that a similar TDMA scheme may be used for scheduling communications between different ESL devices.

In ESL systems with significant numbers of ESL devices, the ESL devices may be configured to communicate with the AP in different groups, where each group may correspond to a different time frame. For example, a first group of ESL devices (ESL1-ESL5) in FIG. 3 may be configured to communicate with the AP during a first time frame 310, and a second group of ESL devices (ESL6-ESL10) may be configured to communicate with the AP during a second time frame 320. The first and second time frames 310 and 320 may alternate during operation of the wireless network. The AP in this example may transmit or broadcast information that is received by the first group of ESL devices during a first time period (or time slot) 302 in the first time frame 310. The ESL devices in this first group may transmit information to the AP during subsequent time periods/slots in the time frame 310. For example, the first ESL device (ESL1) may transmit information received by the AP during a time period 304A, with the other ESL devices (ESL2-ESL5) in this group transmitting during time periods 304B-304E, respectively, in the time frame 310. Likewise, the AP may transmit information received by the second group of ESL devices during a time period 306 in the second time frame 320. The ESL devices (ESL6-ESL10) in this second group may transmit information received by the AP during respective time periods 308A-308E in the time frame 320.

An ESL device may include components configured together to provide some or all of the functionality described in this disclosure and/or provide additional functionality. FIG. 4 is a block diagram illustrating an example configuration of an ESL device 400 according to some embodiments of this disclosure. For example, the ESL device 400 may be used to implement each of the ESL devices (including the ESL devices 108A-108D) of the ESL system 100 described above with respect to FIGS. 1A-2B. As shown in FIG. 4, the ESL device 400 may include a low-power microcontroller 410 configured to provide ESL device functionality in accordance with embodiments of this disclosure. Although functionality for the ESL device may be configured by the microcontroller 410 in embodiments of this disclosure, any single or combination of processors (e.g., at least one processor) may be used to perform the functions described with respect to embodiments of this disclosure.

The microcontroller 410 may include a memory 416. The memory 416 may store computer program code that causes a microprocessor 414 to execute operations that carry out some or all of the functionality described with respect to various embodiments of this disclosure. Although shown as part of the microcontroller 410, the memory 416 may be located internal to or external to the microcontroller 410. The microcontroller 410 may also include one or more wireless radio(s) 412. The wireless radio(s) 412 may include, for example, a Bluetooth wireless radio with a front end that couples to an antenna 408 for transmitting and receiving radio frequency (RF) signals at one or more frequencies in one or more frequency bands. In some embodiments, the microcontroller 410 is a System on Chip (SoC) in which two or more components of the wireless radio(s) 412, the microprocessor 414, and/or the memory 416 are included in a single semiconductor package. In some embodiments, the two or more components may be included on a single semiconductor die.

The ESL device 400 may include I/O devices, such as a notification LED 402 and/or an electronic display 404. The notification LED 402 may include one or more light emitting diodes (LEDs), or other light sources configured to flashlight of one or more colors. The notification LED may be triggered to blink at a specific time and/or with a specific color based on a command received from the gateway node 120. For example, a notification LED 402 may blink to attract a user's attention to a particular location on a shelf. The electronic display 404 may be, for example, an e-ink display configured to output the product information.

The ESL device 400 may couple to a battery 406 or other power source to power operations performed by the ESL device 400, such as to operate the wireless radio(s) 412, the notification LED 402, the electronic display 404, the memory 416, and/or the microprocessor 414. The battery 406 may allow placement of the ESL device 400 in a place where constant power supply is difficult. Thus, in order that a single battery charge provides a long period of use (e.g., lasting longer than several years), the ESL device 400 may be configured to reduce power consumption during times when frequent commands are not expected. For example, the ESL device 400 may operate using a wakeup communication scheme. That is, the ESL device 400 wakes up according to predetermined time intervals to determine whether data is waiting to be received. When no data is waiting, power to the ESL device 400 is turned off until the next wakeup period to reduce power consumption. When there is data to be received or transmitted, the ESL device 400 wakes up to perform communication operations. For example, the ESL device 400 may wake up in response to receiving a command message transmitted by a management server (e.g., management server 122 of FIG. 1B) of the ESL system via a gateway node (e.g., gateway node 120 of FIG. 1B), as described above.

In some embodiments, the command messages transmitted by the management server may include commands for configuring one or more energizer devices of the ESL infrastructure to transmit radio waves for energizing an ambient device in a vicinity of the energizer device(s). The management server may also transmit additional command messages for configuring other devices of the ESL infrastructure (e.g., the APs 106A and 106B and the ESL devices 108A-108D of FIG. 1B) to listen for and/or receive signals transmitted by the ambient device after being energized by the energizing radio waves from the energizer device(s). As will be described in further detail below with respect to FIGS. 5-7, the energizers and other devices may be configured by the management server as part of a fingerprinting process to estimate or determine a position of the ambient device within the environment based, at least in part, on positioning data relating to characteristics of signal transmissions received by one or more of the ESL infrastructure devices from the ambient device during a positioning phase of the fingerprinting process.

It is noted that one or more blocks (or operations) described above with reference to FIGS. 1A-4 may be combined with one or more blocks (or operations) described below with reference to one or more of FIGS. 5-7. For discussion purposes, the examples of FIGS. 5-7 will be described below with reference to the ESL system and energizer subsystem of the corresponding ESL infrastructure deployed within the environment as described above with respect to FIGS. 1A-4. However, it should be appreciated that the disclosed energizer-based fingerprinting techniques are not intended to be limited thereto and that these techniques may be applied to any of various ESL systems and infrastructures for positioning ambient devices within any of various environments.

FIG. 5 is a block diagram illustrating an example configuration of an ambient device 500 according to some embodiments of this disclosure. Ambient device 500 may include a low-power microcontroller 510 used to provide positioning functionality in accordance with embodiments of this disclosure. Although functionality for the ambient device 500 may be configured by the microcontroller 510 in the example of FIG. 5, any single or combination of processors (e.g., at least one processor) may be used to perform the functions described with respect to embodiments of this disclosure.

Like the microcontroller 410 of the ESL device 400 in the example of FIG. 4 described above, the microcontroller 510 of the ambient device 500 in this example may include one or more wireless radios 512, a microprocessor 514, and a memory 516. The memory 516 may store computer program code that causes the microprocessor 514 to execute operations that carry out some or all of the functionality described with respect to various embodiments of this disclosure. Although shown as part of the microcontroller 510, the memory 516 may be located internal to or external to the microcontroller 510. The wireless radio(s) 512 may include, for example, a Bluetooth wireless radio with a front end that couples to an antenna 508 for transmitting and receiving RF signals at one or more frequencies in one or more frequency bands. In some embodiments, the microcontroller 510 may be implemented as a SoC with the wireless radio(s) 512, the microprocessor 514, and/or the memory 516 included in a single semiconductor package, e.g., on a single semiconductor die.

Unlike the ESL device 400 of FIG. 4, the ambient device 500 in FIG. 5 does not include a battery or other internal power source. Instead, the ambient device 500 may include an energy harvester 520, which collects energy from ambient signals received from one or more external sources via the antenna 508. In some embodiments, the one or more external sources may include one or more energizer devices of an ESL infrastructure deployed within the environment, as described above. For example, the energizer device(s) in a vicinity of the ambient device 500 may transmit radio waves for energizing the ambient device 500. The energy harvester 520 may convert ambient energy from the radio waves received via the antenna 508 into electrical energy that can be used to power the microcontroller 510 and one or more of its components (e.g., one or more of the wireless radio(s) 512, the microprocessor 514, and the memory 516), as required to perform one or more operations of the ambient device 500. In some implementations, the energy harvester 520 may include a capacitor for storing the harvested electrical energy before it is used to power the microcontroller 510 or component(s) thereof.

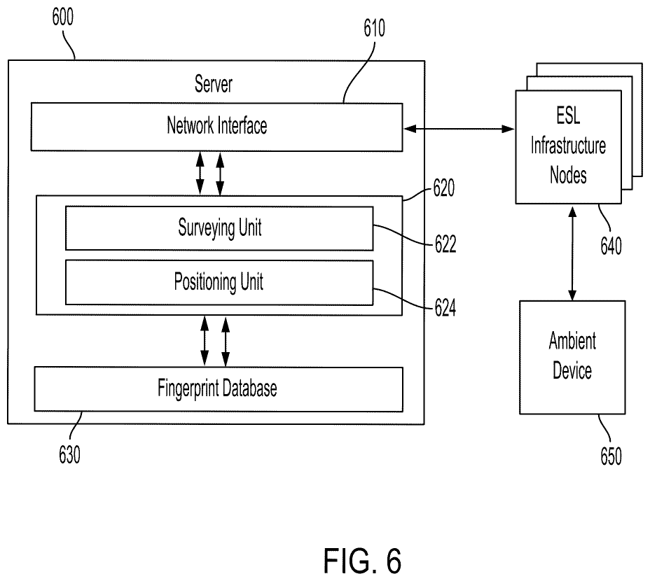

In some embodiments, the energizer transmissions and subsequent operations of the ambient device 500 may be performed during a positioning phase of a fingerprinting process initiated by a server of the ESL system (e.g., the management server 122 of ESL system 100 of FIG. 1B, as described above) to determine a position of the ambient device 500 within the environment, as will be described in further detail below with reference to FIG. 6.

FIG. 6 is a block diagram of an example server 600 for positioning an ambient device using an energizer subsystem of an ESL infrastructure deployed within an environment according to some embodiments of this disclosure. The server 600 may be used to implement, for example, a management server of an ESL system (e.g., management server 122 of the ESL system 100 of FIG. 1B, as described above) deployed within an environment (e.g., retail environment 110 of FIGS. 1A and 1B, as described above). As shown in FIG. 6, the server 600 includes a network interface 610, a fingerprint manager 620, and a fingerprint database 630. The fingerprint manager 620 includes a surveying unit 622 and a positioning unit 624.

As will be described in further detail below, the server 600 and its components or subcomponents (including the surveying unit 622 and the positioning unit 624 of the fingerprint manager 620) may use the network interface 610 to communicate with various ESL infrastructure nodes 640 and an ambient device 650 located within the environment via a communication network. Such a network may be any network or combination of networks that can carry data communications according to any of various communication standards. The network may include, but is not limited to, a wired or a wireless network. The network may also include a local area network, a medium area network, or a wide area network, such as the Internet. The network and network interface 610 may support any of various networking protocols and technologies as desired for a particular implementation.

The ESL infrastructure nodes 640 may include dedicated devices or components of the ESL system infrastructure deployed within the environment. Examples of such infrastructure devices include, but are not limited to, ESL devices (e.g., ESL devices 108A-108D of FIG. 1B), access points (e.g., access points 106A and 106B of FIG. 1B), one or more gateway nodes (e.g., gateway node 120 of FIG. 1B), and energizer devices (e.g., energizer 204 of FIG. 2A) used to supply power to other infrastructure nodes over a wireless network. It may be assumed that the respective locations of these infrastructure devices are already known. For example, the location of each infrastructure device or node may have been previously determined by the surveying unit 622 during a surveying or training phase of a fingerprinting process performed by the server 600 using the fingerprint manager 620.

In some embodiments, the surveying phase may involve a user (e.g., a store worker associated with a retail environment) calibrating a known location for each of the ESL infrastructure nodes 640 while deploying or installing the node or device within the environment. Additionally or alternatively, the location of each node/device may be calibrated during a survey of the environment. The deployment of each device and/or survey of the environment may be performed by the user via an application executable at a mobile device of the user while the user moves with the mobile device through the environment. For example, the user may use the application to enter coordinates for the location of each device along with a set of positioning measurements associated with the location. The application may then transfer the coordinates and positioning measurements to the server 600 via a wireless network. In some implementations, the survey may be conducted using a survey device coupled to an automated robot, such as an autonomous guided vehicle. For example, the survey device may automatically transmit the location coordinates and positioning measurements for each infrastructure node to the server 600 via the wireless network as the robot (or autonomous vehicle) and survey device move through the environment.

In some embodiments, the known location of each infrastructure node may be a coarse location that corresponds to a general zone, region, or other area of the environment (such as an aisle, gondola, or shelf) in which the node is located. The coarse location may be manually entered into an ERP system (e.g., by the store worker or automated robot) during deployment. In some cases, the coarse location may serve as an initial position estimate for the infrastructure node that may be refined using any of various positioning techniques. For example, a more precise location of each infrastructure node may be determined based on a combination of RF measurements (e.g., received signal strength indicator (RSSI) values) collected for the node by the survey device and a set of parameters for transmissions received by the node from one or more energizer devices in a vicinity of the node during the survey of the environment. In some implementations, the energizer transmissions may be multiplexed in the time domain (e.g., over different time slots) to avoid interference. Alternatively, multiple transmissions may be overlapped in the same time slot in order to consider the impact of interference that may occur during a subsequent testing or positioning phase of the fingerprinting process, as will be described in further detail below.

In some embodiments, the transmission parameters associated with each energizer transmission may include an energizer ID, a transmission power, a time slot, beam information (e.g., beam ID and type), and a channel. As described above, the positioning measurements recorded for each ESL infrastructure node may serve as a ground truth for signal reception characteristics associated with a known location of that node within the environment. Accordingly, a set of energizer transmission parameters (such as a range of transmission powers, time slots, beams, and channels for each energizer ID) corresponding to the energizer transmissions may represent additional ground truth data recorded during the training/surveying phase of the fingerprinting process for each ESL infrastructure node at a known location. The additional ground truth data relating to the energizer transmissions received by each node may be used to enrich or augment the initial ground truth data (positioning measurements) collected for that node at the corresponding location.

In some embodiments, the surveying unit 622 may use the network interface 610 of the server 600 to receive the ground truth data (including positioning measurements and set of energizer transmission parameters) for each of various nodes of an ESL infrastructure deployed at known locations within the environment. The surveying unit 622 may store the ground truth data received for each node together with a known location of that node in the fingerprint database 630 for later access and retrieval during the positioning phase of the fingerprinting process performed using the positioning unit 624.

During the positioning phase, the positioning unit 624 may configure one or more energizer devices of the ESL infrastructure (corresponding to one or more nodes of the ESL infrastructure) to transmit radio waves for energizing an ambient device 650 in a vicinity of the energizer device(s). For example, the positioning unit 624 may transmit via the wireless network one or more command messages configuring the energizer device(s) to transmit the energizing radio waves according to a set of transmission parameters. The set of transmission parameters may include a range of transmission powers, a set of time slots, a set of beams (including corresponding beam identifiers (IDs) and/or beam types), and a set of channels (e.g., over a specified frequency band).

In some embodiments, the ambient device 650 may include energy harvesting circuitry (e.g., similar to energy harvester 520 of ambient device 500 of FIG. 5) that is capable of transmitting the beacon message using energy that is harvested from a signal received from the energizer(s) (e.g., in a continuous and full-duplex manner). Accordingly, the transmissions by the ambient device 650 may sweep over a range of transmission powers similar to that of the energizer's transmissions. For example, the ambient device 650 may be energized by a transmission from the energizer including energizing waveforms over a first frequency band (e.g., over the 900 MHz band). The ambient device 650 in this example may in turn transmit a beacon message on-the-go over a second band (the 2.4 GHz band). Alternatively, the ambient device 650 may transmit its beacon message over the first band (e.g., 900 MHz), but on a carrier frequency that is offset from the frequency of the ongoing transmissions received from the energizer.

Subsequent to being energized by the energizer(s)' transmissions, the ambient device 650 may transmit a beacon message in the form of beacon signals that may be received by one or more of the ESL infrastructure nodes 640 (e.g., including one or more ESL devices and/or APs) in a vicinity of the ambient device 650. In some embodiments, the ambient device 250 may choose to transmit the beacon message using a transmission power that is proportional to the power of the energizing waveform received from the energizer(s). The beacon message transmitted by the ambient device 650 may include a first indication of the transmission power selected and used for its beacon transmission. The first indication of the transmission power may correspond to a certain number of bits (e.g., up to some number N bits) of the message. The beacon message may also include a second indication of whether the beacon message includes the first indication of the transmission power (e.g., one bit of the message to denote enabled (1) or disabled (0)). The message may further include a third indication (e.g., up to another N bits of the message) of the amount of time spent harvesting the energizing waveforms from the energizer(s) (e.g., in terms of milliseconds or other known granularity). The beacon message may also include identification information for the ambient device 650.

The ESL infrastructure nodes 640 that receive the beacon message from the ambient device 650 may perform positioning measurements based on the signals received with the beacon message and relay the message to the server 600 via the wireless network. The information contained in the beacon message may be used by the server 600 to identify the specific ambient device 650 and improve its energizing performance. In some embodiments, the positioning unit 624 of the fingerprint manager 620 at the server 600 may use the indication of the transmission power embedded in the beacon message received by the ESL infrastructure nodes 640 on the uplink from the ambient device to gauge the energizing signal quality of the energizer transmissions received by the ambient device 650 on the downlink from the one or more energizer devices. For example, a transmission power of the beacon message that meets or exceeds a minimum threshold transmission power may suggest that the energizing signal quality of the energizer transmissions and energizing performance of the corresponding energizer(s) is sufficient. Conversely, a transmission power that fails to meet (e.g., is less than) the minimum threshold power may suggest that the energizing performance of the energizer(s) need improvement.

To improve energizing performance, the positioning unit 624 may configure each of the energizers in a vicinity of the ambient device 650 (e.g., as identified by a corresponding energizer ID included in each energizer transmission and resulting beacon message transmitted by the ambient device 650) to transmit energizing radio waves over a specified transmission power, time slot index, beam ID, and/or channel. For example, the positioning unit 624 may reconfigure each of the energizers to increase the transmission power of the energizing radio waves transmitted to the ambient device 650 and thereby improve the energizing signal quality and selected transmission power of the subsequent beacon signal transmissions made by the ambient device 650. The testing of the energizing performance and configuring (or reconfiguring) of transmission parameters for each energizer may be repeated over any number of iterations until the transmission power of the beacon messages of the ambient device 650 (and other ambient devices in the vicinity of the energizer) meets the minimum threshold transmission power. This may help to ensure that multiple ambient devices are energized effectively before the ESL infrastructure nodes 640 perform positioning measurements or before such measurements are considered valid.

Furthermore, to avoid interference caused by multiple ambient devices or tags transmitting to the same set of ESL infrastructure nodes 640 in an area or region of the environment, the positioning unit 624 may group various ambient devices based on their respective transmission power values. For example, ambient tags that transmit beacon signals at relatively lower transmission powers may be grouped together for transmission, so that stronger tags do not interfere and subdue the weaker ones. Additionally or alternatively, different groups of ambient devices may be configured to transmit at randomly assigned timing and/or frequency (or channel) offsets based on a ranked order of their corresponding transmission power values (e.g., as inferred from their respective beacon signals/messages relayed to the server 600 by one or more of the ESL infrastructure nodes 640). For example, ambient devices in a first group may include devices with transmission powers in the range of 0 to −5 dBm, while a second group includes devices with transmission powers in the range of −5 to −10 dBm, and so on. A unique offset for transmissions may be assigned to each of these groups, and an additional smaller random offset may be assigned to each ambient device within each group. As the individual ambient devices are low-cost devices that may be incapable of demodulation, information about the offsets for each ambient device may be either pre-configured (e.g., stored in the device firmware for processing) or implicitly indicated by the presence or absence of certain tones in the energizing signal transmitted by the one or more energizers in the vicinity of each ambient device.

In addition to scheduling the ambient devices to account for signal interference caused by other ambient devices within the environment, as described above, the fingerprinting process may be scheduled for one or more groups of ESL infrastructure nodes 640 (e.g., energizers and/or ESL devices) to conserve power during the fingerprinting process. The fingerprinting process may become increasingly power-intensive for the individual nodes 640 within the environment as the total number of nodes with which each node must communicate grows. This is especially true for listening nodes (such as battery-powered ESL devices), which may be required to wake up and listen for and/or receive positioning signals over extended periods of time.

In some embodiments, the positioning unit 624 may schedule one or more groups of ESL devices and/or energizers to listen for and/or receive transmissions from other energizers during time slots when the other energizers are scheduled to transmit energizing signals. The transmissions received by an energizer (or ESL device) from another energizer may be harvested and stored as energy for future transmissions. This allows the ESL infrastructure nodes 640 (e.g., the energizers and/or ESL devices) to periodically replenish energy that is typically lost during the fingerprinting process.

In some embodiments, the server 600 may receive, via the wireless network from the ESL infrastructure nodes 640 in a vicinity of the ambient device 650, positioning data relating to the signal transmissions received by the ESL infrastructure node(s) 640 from the ambient device 650 based on the energizing waveforms transmitted by the one or more energizer devices. The signal transmissions may be made by the ambient device 650 according to one or more parameters selected from a set of transmission parameters (e.g., transmission power, time slot, beam ID, and channel) associated with the transmissions received by the ambient device 650 from the energizer device(s). Such positioning data may include, for example, a set of positioning measurements (e.g., a set of RSSI values) of the beacon signals received from the ambient device 650, e.g., after a certain number of iterations of energizing transmissions and reconfiguring of energizers have been completed to meet the minimum threshold transmission power, as described above. The positioning data may also include values of one or more transmission parameters corresponding to the energizing waveforms transmitted by the one or more energizer devices in the vicinity of the ambient device 650. In some embodiments, the set of positioning measurements (or RSSI values) measured by the ESL infrastructure nodes 640 may vary over the one or more parameters selected from the set of transmission parameters (e.g., over one or more of a range of transmission powers, a set of time slots, a set of beam IDs, and a set of channels).

In some implementations, the position data (including the positioning measurements together with the energizer transmission (Tx) parameters) may represent a fingerprint of the signal transmissions from the ambient device 650. The fingerprint may include, for example, multiple elements, where each element may include various RSSI values measured by the ESL infrastructure nodes 640 (e.g., one or more ESL devices and/or APs) for a different combination of energizer transmission parameters. For example, the positioning data corresponding to such an element for a fingerprint of the ambient device (or tag) 650 may include the following sets of energizer parameters and signal strength measurements:
{Energizer ID (1), Energizer Tx (20 dBm), Time slot (1), Beam ID (5), Channel (2)}; {Tag Tx Power (−10 dBm)};
{Measured RSSI @ESL1 (−80 dBm), Measured RSSI @ESL2 (−78 dBm), . . . , Measured RSSI @APi (−82 dBm), . . . }.

While the set of transmission parameters for only one energizer and the measurements for only three infrastructure nodes are shown in the above example, it should be appreciated that the fingerprint associated with the ambient device 650 may include the transmission parameters for any number of other infrastructure nodes. For example, the complete fingerprint may include multiple elements similar to the one above for various combinations of energizer transmission parameters and tag transmission powers corresponding to the transmissions received by the nodes 640 from the ambient device 650. For a given fingerprint, implicit statistics on the measured RSSI, such as the average or median RSSI (taken over a range of time slots or a time period), may also be computed and maintained.

In some embodiments, the positioning unit 624 of the server 600 may compare the positioning data relating to the signal transmissions from the ambient device 650 with the ground truth data from the fingerprint database 630 relating to the energizer transmissions received by each of the ESL infrastructure nodes 640 at a known (or ground truth) location of that device/node within the environment. Based on the comparison, the positioning unit 624 may identify at least one device of the ESL infrastructure for which the ground truth data matches the positioning data. The positioning unit 624 may then determine a position of the ambient device within the environment based on the known location of the at least one device. In some implementations, the positioning unit 624 may first identify a coverage region (or search space) for locating the ambient device 650 within the environment based on a known layout or map of environment and the energizer parameters associated with each known location (and corresponding node of the ESL infrastructure). The positioning unit 624 may then determine the position of the ambient device 650 within the identified region.

In some embodiments, the fingerprint manager 620 may use a machine learning model to perform the matching of the ground truth data in the fingerprint database 630 with the positioning data received from ESL infrastructure nodes 640 for the ambient device 650. For example, the ground truth data received by the surveying unit 622 may be used to train the machine learning model during the training or surveying phase of the fingerprinting process. During the subsequent testing or positioning phase of the fingerprinting process, the positioning unit 624 may apply the positioning data received for the ambient device 650 along with at least a subset of the ground truth data from the fingerprint database 630 as inputs to the trained machine learning model to determine a position of the ambient device 650 within the environment. Any of various machine learning algorithms or models suitable for performing such matching operations may be used as desired for a particular implementation. Examples of such machine learning models include, but are not limited to, a recurrent neural network (RNN) or other deep neural network (DNN), a long-short-term-memory (LSTM) model, a k-nearest neighbor model, a random forest model, and other machine learning models using logistic regression and/or probabilistic matching.

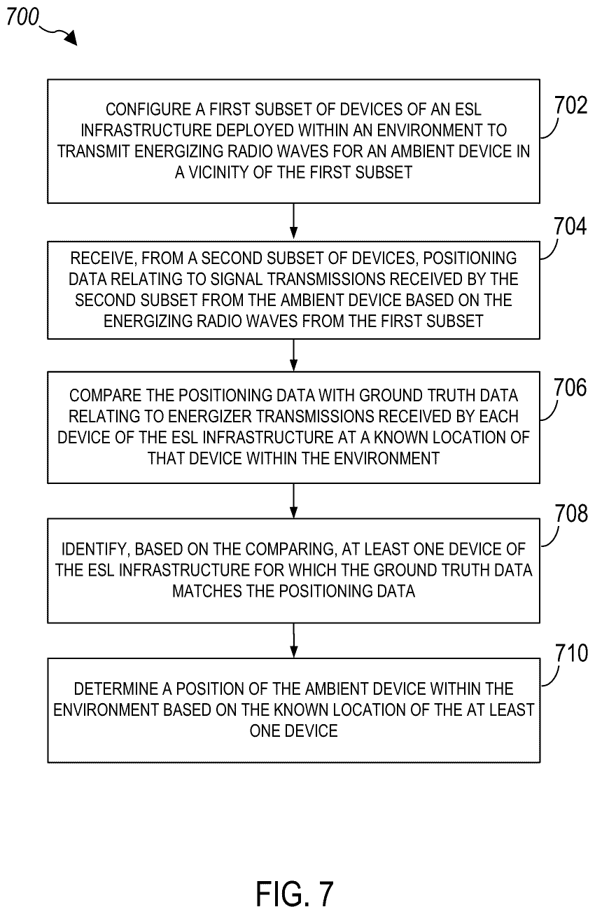

FIG. 7 is a flow chart of an example method 700 for positioning ambient devices within an environment using energizers and other devices of an ESL infrastructure deployed in the environment according to some embodiments of this disclosure. Method 700 may be performed by, for example, a server of an ESL system corresponding to the ESL infrastructure deployed within the environment. For discussion purposes, method 700 will be described using the ESL system 100 of FIG. 1B, as described above, and/or the server 600 of FIG. 6, as described above. However, the method 700 is not intended to be limited thereto. For example, method 700 including the operations in the blocks described below may be performed by the management server 122 of the ESL system 100 or by components of the server 600, as described above.

Method 700 begins at block 702, which includes configuring (e.g., via a wireless network) a first subset of devices of an electronic shelf label (ESL) infrastructure deployed within an environment to transmit energizing radio waves for an ambient device in a vicinity of the first subset. The first subset of devices may include, for example, one or more energizer devices, as described above.

Method 700 then proceeds to block 704, which includes receiving, from a second subset of devices of the ESL infrastructure (e.g., one or more ESL devices and/or APs), positioning data relating to signal transmissions received by the second subset from the ambient device based on the energizing radio waves from the first subset.

At block 706, the positioning data is compared with ground truth data relating to energizer transmissions received by each device of the ESL infrastructure at a known location of that device within the environment. The energizer transmissions may have been received by each device during a surveying or training phase of the fingerprinting process performed by the server, as described above. The ground truth data relating to the received energizer transmissions may be stored in a fingerprint database (e.g., fingerprint database 630 of FIG. 6, as described above).

Based on the comparison performed at block 706, at least one device of the ESL infrastructure for which the ground truth data matches the positioning data may be identified at block 708.

Method 700 then proceeds to block 710, which includes determining a position of the ambient device within the environment based on the known location of the at least one device identified at block 708.

In one or more aspects, techniques for supporting ESL systems may include additional aspects, such as any single aspect or any combination of aspects described below or in connection with one or more other processes or devices described elsewhere herein.

In a first aspect, a method comprises: configuring, by a server, a first subset of devices to transmit energizing radio waves for an ambient device in a vicinity of the first subset; receiving, by the server from a second subset of devices, positioning data relating to signal transmissions received by the second subset from the ambient device based on the energizing radio waves from the first subset; comparing, by the server, the positioning data with ground truth data correlating devices with known locations; identifying, by the server based on the comparing, at least one matching device for which the ground truth data matches the positioning data; and determining, by the server, a position of the ambient device based on a corresponding known location of the at least one matching device.

In a second aspect, in combination with the first aspect, the ambient device is an ambient Internet of Things (IoT) tag associated with an item of inventory.

In a third aspect, in combination with one or more of the first aspect or the second aspect, the first subset includes one or more energizer devices configured by the server to transmit energizing waveforms for powering electrical components of the ambient device.

In a fourth aspect, in combination with one or more of the first aspect through the third aspect, the one or more energizer devices are configured by the server to transmit the energizing waveforms according to a set of transmission parameters, and wherein the signal transmissions are made by the ambient device according to the set of transmission parameters.

In a fifth aspect, in combination with one or more of the first aspect through the fourth aspect, the second subset includes at least one of an electronic shelf label (ESL) device or an access point, and wherein the positioning data includes measurements of the signal transmissions received by the second subset.

In a sixth aspect, in combination with one or more of the first aspect through the fifth aspect, the measurements include a set of received signal strength indicator (RSSI) values measured by the second subset for the signal transmissions received from the ambient device.

In a seventh aspect, in combination with one or more of the first aspect through the sixth aspect, the set of RSSI values measured by the second subset vary over each of the one or more transmission parameters selected from the set of transmission parameters.

In an eighth aspect, in combination with one or more of the first aspect through the seventh aspect, the set of transmission parameters include at least one of a transmission power, a time slot, a beam identifier (ID), or a channel, and the set of RSSI values measured by each device vary over one or more of a range of transmission powers, a set of time slots, a set of beam identifiers (IDs), or a set of channels.

In a ninth aspect, in combination with one or more of the first aspect through the eighth aspect, the signal transmissions made by the ambient device include a beacon message transmitted by the ambient device according to a selected transmission power that is proportional to the transmission power of the energizing radio waves received by the ambient device from the one or more energizer devices.

In a tenth aspect, in combination with one or more of the first aspect through the ninth aspect, the beacon message includes an indication of the selected transmission power, the beacon message is received by the server from the second subset, and the method further comprises: determining, by the server, that the selected transmission power fails to meet a minimum threshold transmission power; reconfiguring, by the server, the one or more energizer devices to increase the transmission power of the energizing radio waves transmitted to the ambient device; and receiving, by the server, the positioning data from the second subset based on additional signal transmissions received by the second subset from the ambient device after the energizing radio waves are transmitted with the increased transmission power.

In an eleventh aspect, in combination with one or more of the first aspect through the tenth aspect, the ambient device is one of a plurality of ambient devices, and the method further comprises: ranking, by the server, the plurality of ambient devices according to the selected transmission power of respective signal transmissions made by each ambient device of the plurality of ambient devices; grouping, by the server, the plurality of ambient devices into different groups of ambient devices based on the ranking, each group of ambient devices corresponding to a different range of selected transmission powers; and assigning, by the server to each group of ambient devices, a timing offset for the additional signal transmissions to be made by the ambient devices in that group.

In a twelfth aspect, an apparatus includes a memory storing processor-readable code and at least one processor coupled to the memory, wherein the at least one processor configured to execute the processor-readable code to cause the at least one processor to perform operations comprising: configuring a first subset of devices to transmit energizing radio waves for an ambient device in a vicinity of the first subset; receiving, from a second subset of devices, positioning data relating to signal transmissions received by the second subset from the ambient device based on the energizing radio waves from the first subset; comparing the positioning data with ground truth data correlating devices with known locations; identifying, based on the comparing, at least one matching device for which the ground truth data matches the positioning data; and determining a position of the ambient device based on a corresponding known location of the at least one matching device.

In a thirteenth aspect, in combination with the twelfth aspect, the ambient device is an ambient Internet of Things (IoT) tag associated with an item of inventory.

In a fourteenth aspect, in combination with one or more of the twelfth aspect or the thirteenth aspect, the first subset includes one or more energizer devices configured to transmit energizing waveforms for powering electrical components of the ambient device.

In a fifteenth aspect, in combination with one or more of the twelfth aspect through the fourteenth aspect, the one or more energizer devices are configured to transmit the energizing waveforms according to a set of transmission parameters, and the signal transmissions are made by the ambient device according to the set of transmission parameters.

In a sixteenth aspect, in combination with one or more of the twelfth aspect through the fifteenth aspect, the second subset includes at least one of an electronic shelf label (ESL) device or an access point, and the positioning data includes measurements of the signal transmissions received by the second subset.

In a seventeenth aspect, in combination with one or more of the twelfth aspect through the sixteenth aspect, the measurements include a set of received signal strength indicator (RSSI) values measured by the second subset for the signal transmissions received from the ambient device.

In an eighteenth aspect, in combination with one or more of the twelfth aspect through the seventeenth aspect, the set of RSSI values measured by the second subset vary over each of the one or more transmission parameters selected from the set of transmission parameters.

In a nineteenth aspect, in combination with one or more of the twelfth aspect through the eighteenth aspect, the set of transmission parameters include at least one of a transmission power, a time slot, a beam identifier (ID), or a channel, and the set of RSSI values measured by each device vary over one or more of a range of transmission powers, a set of time slots, a set of beam identifiers (IDs), or a set of channels.

In a twentieth aspect, in combination with one or more of the twelfth aspect through the nineteenth aspect, the signal transmissions made by the ambient device include a beacon message transmitted by the ambient device according to a selected transmission power that is proportional to the transmission power of the energizing radio waves received by the ambient device from the one or more energizer devices.

In a twenty-first aspect, in combination with one or more of the twelfth aspect through the twentieth aspect, the beacon message includes an indication of the selected transmission power, the beacon message is received from the second subset, and the operations further comprise: determining that the selected transmission power fails to meet a minimum threshold transmission power; reconfiguring the one or more energizer devices to increase the transmission power of the energizing radio waves transmitted to the ambient device; and receiving the positioning data from the second subset based on additional signal transmissions received by the second subset from the ambient device after the energizing radio waves are transmitted with the increased transmission power.

In a twenty-second aspect, in combination with one or more of the twelfth aspect through the twenty-first aspect, the ambient device is one of a plurality of ambient devices, and the operations further comprise: ranking the plurality of ambient devices according to the selected transmission power of respective signal transmissions made by each ambient device of the plurality of ambient devices; grouping the plurality of ambient devices into different groups of ambient devices based on the ranking, each group of ambient devices corresponding to a different range of selected transmission powers; and assigning, to each group of ambient devices, a timing offset for the additional signal transmissions to be made by the ambient devices in that group.

In a twenty-third aspect, a non-transitory computer-readable medium stores instructions that, when executed by a processor, cause the processor to perform operations comprising: configuring a first subset of devices to transmit energizing radio waves for an ambient device in a vicinity of the first subset; receiving, from a second subset of devices, positioning data relating to signal transmissions received by the second subset from the ambient device based on the energizing radio waves from the first subset; comparing the positioning data with ground truth data correlating devices with known locations; identifying, based on the comparing, at least one matching device for which the ground truth data matches the positioning data; and determining a position of the ambient device based on a corresponding known location of the at least one matching device.

In a twenty-fourth aspect, in combination with the twenty-third aspect, the ambient device is an ambient Internet of Things (IoT) tag associated with an item of inventory.

In a twenty-fifth aspect, in combination with one or more of the twenty-third aspect or the twenty-fourth aspect, the first subset includes one or more energizer devices configured to transmit energizing waveforms for powering electrical components of the ambient device.

In a twenty-sixth aspect, in combination with one or more of the twenty-third aspect through the twenty-fifth aspect, the one or more energizer devices are configured to transmit the energizing waveforms according to a set of transmission parameters, and the signal transmissions are made by the ambient device according to the set of transmission parameters.

In a twenty-seventh aspect, in combination with one or more of the twenty-third aspect through the twenty-sixth aspect, the second subset includes at least one of an electronic shelf label (ESL) device or an access point, and the positioning data includes measurements of the signal transmissions received by the second subset.

In a twenty-eighth aspect, an electronic shelf label (ESL) system comprises: a first subset of devices; a second subset of devices; and a server comprising a memory and at least one processor coupled to the memory, wherein the at least one processor is configured to perform operations comprising: configuring the first subset of devices to transmit energizing radio waves for an ambient device in a vicinity of the first subset; receiving, from the second subset of devices, positioning data relating to signal transmissions received by the second subset from the ambient device based on the energizing radio waves from the first subset; comparing the positioning data with ground truth data correlating devices with known locations; identifying, based on the comparing, at least one matching device for which the ground truth data matches the positioning data; and determining a position of the ambient device based on a corresponding known location of the at least one matching device.

In a twenty-ninth aspect, in combination with the twenty-eighth aspect, the ambient device is an ambient Internet of Things (IoT) tag associated with an item of inventory.

In a thirtieth aspect, in combination with one or more of the twenty-eighth aspect or the twenty-ninth aspect, the first subset includes one or more energizer devices configured to transmit energizing waveforms for powering electrical components of the ambient device, the second subset includes at least one of an ESL device or an access point, and the positioning data includes measurements of the signal transmissions received by the second subset.

Components, the functional blocks, and the modules described herein with respect to the figures described above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a non-transitory computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method comprising:
configuring, by a server, a first subset of devices to transmit energizing radio waves for an ambient device in a vicinity of the first subset;
receiving, by the server from a second subset of devices, positioning data relating to signal transmissions received by the second subset from the ambient device based on the energizing radio waves from the first subset;
comparing, by the server, the positioning data with ground truth data correlating devices with known locations;
identifying, by the server based on the comparing, at least one matching device for which the ground truth data matches the positioning data; and
determining, by the server, a position of the ambient device based on a corresponding known location of the at least one matching device.

2. The method of claim 1, wherein the ambient device is an ambient Internet of Things (IoT) tag associated with an item of inventory.

3. The method of claim 1, wherein the first subset includes one or more energizer devices configured by the server to transmit energizing waveforms for powering electrical components of the ambient device.

4. The method of claim 3, wherein the one or more energizer devices are configured by the server to transmit the energizing waveforms according to a set of transmission parameters, and wherein the signal transmissions are made by the ambient device according to the set of transmission parameters.

5. The method of claim 4, wherein the second subset includes at least one of an electronic shelf label (ESL) device or an access point, and wherein the positioning data includes measurements of the signal transmissions received by the second subset.

6. The method of claim 5, wherein the measurements include a set of received signal strength indicator (RSSI) values measured by the second subset for the signal transmissions received from the ambient device.

7. The method of claim 6, wherein the set of RSSI values measured by the second subset vary over each of the one or more transmission parameters selected from the set of transmission parameters.

8. The method of claim 7, wherein:
the set of transmission parameters include at least one of a transmission power, a time slot, a beam identifier (ID), or a channel; and
the set of RSSI values measured by each device vary over one or more of a range of transmission powers, a set of time slots, a set of beam identifiers (IDs), or a set of channels.

9. The method of claim 8, wherein the signal transmissions made by the ambient device include a beacon message transmitted by the ambient device according to a selected transmission power that is proportional to the transmission power of the energizing radio waves received by the ambient device from the one or more energizer devices.

10. The method of claim 9, wherein the beacon message includes an indication of the selected transmission power, wherein the beacon message is received by the server from the second subset, and wherein the method further comprises:
determining, by the server, that the selected transmission power fails to meet a minimum threshold transmission power;
reconfiguring, by the server, the one or more energizer devices to increase the transmission power of the energizing radio waves transmitted to the ambient device; and
receiving, by the server, the positioning data from the second subset based on additional signal transmissions received by the second subset from the ambient device after the energizing radio waves are transmitted with the increased transmission power.

11. The method of claim 10, wherein the ambient device is one of a plurality of ambient devices, and wherein the method further comprises:
ranking, by the server, the plurality of ambient devices according to the selected transmission power of respective signal transmissions made by each ambient device of the plurality of ambient devices;
grouping, by the server, the plurality of ambient devices into different groups of ambient devices based on the ranking, each group of ambient devices corresponding to a different range of selected transmission powers; and
assigning, by the server to each group of ambient devices, a timing offset for the additional signal transmissions to be made by the ambient devices in that group.

12. An apparatus comprising:
a memory storing processor-readable code; and
at least one processor coupled to the memory, the at least one processor configured to execute the processor-readable code to cause the at least one processor to perform operations comprising:
configuring a first subset of devices to transmit energizing radio waves for an ambient device in a vicinity of the first subset;
receiving, from a second subset of devices, positioning data relating to signal transmissions received by the second subset from the ambient device based on the energizing radio waves from the first subset;
comparing the positioning data with ground truth data correlating devices with known locations;
identifying, based on the comparing, at least one matching device for which the ground truth data matches the positioning data; and
determining a position of the ambient device based on a corresponding known location of the at least one matching device.

13. The apparatus of claim 12, wherein the ambient device is an ambient Internet of Things (IoT) tag associated with an item of inventory.

14. The apparatus of claim 12, wherein the first subset includes one or more energizer devices configured to transmit energizing waveforms for powering electrical components of the ambient device.

15. The apparatus of claim 14, wherein the one or more energizer devices are configured to transmit the energizing waveforms according to a set of transmission parameters, and wherein the signal transmissions are made by the ambient device according to the set of transmission parameters.

16. The apparatus of claim 15, wherein the second subset includes at least one of an electronic shelf label (ESL) device or an access point, and wherein the positioning data includes measurements of the signal transmissions received by the second subset.

17. The apparatus of claim 16, wherein the measurements include a set of received signal strength indicator (RSSI) values measured by the second subset for the signal transmissions received from the ambient device.

18. The apparatus of claim 17, wherein the set of RSSI values measured by the second subset vary over each of the one or more transmission parameters selected from the set of transmission parameters.

19. The apparatus of claim 18, wherein:
the set of transmission parameters include at least one of a transmission power, a time slot, a beam identifier (ID), or a channel; and
the set of RSSI values measured by each device vary over one or more of a range of transmission powers, a set of time slots, a set of beam identifiers (IDs), or a set of channels.

20. The apparatus of claim 19, wherein the signal transmissions made by the ambient device include a beacon message transmitted by the ambient device according to a selected transmission power that is proportional to the transmission power of the energizing radio waves received by the ambient device from the one or more energizer devices.

21. The apparatus of claim 20, wherein the beacon message includes an indication of the selected transmission power, wherein the beacon message is received from the second subset, and wherein the operations further comprise:
determining that the selected transmission power fails to meet a minimum threshold transmission power;
reconfiguring the one or more energizer devices to increase the transmission power of the energizing radio waves transmitted to the ambient device; and
receiving the positioning data from the second subset based on additional signal transmissions received by the second subset from the ambient device after the energizing radio waves are transmitted with the increased transmission power.

22. The apparatus of claim 21, wherein the ambient device is one of a plurality of ambient devices, and wherein the operations further comprise:
ranking the plurality of ambient devices according to the selected transmission power of respective signal transmissions made by each ambient device of the plurality of ambient devices;
grouping the plurality of ambient devices into different groups of ambient devices based on the ranking, each group of ambient devices corresponding to a different range of selected transmission powers; and
assigning, to each group of ambient devices, a timing offset for the additional signal transmissions to be made by the ambient devices in that group.

23. A non-transitory computer-readable medium storing instructions that, when executed by a processor, cause the processor to perform operations comprising:
configuring a first subset of devices to transmit energizing radio waves for an ambient device in a vicinity of the first subset;
receiving, from a second subset of devices, positioning data relating to signal transmissions received by the second subset from the ambient device based on the energizing radio waves from the first subset;
comparing the positioning data with ground truth data correlating devices with known locations;
identifying, based on the comparing, at least one matching device for which the ground truth data matches the positioning data; and
determining a position of the ambient device based on a corresponding known location of the at least one matching device.

24. The non-transitory computer-readable medium of claim 23, wherein the ambient device is an ambient Internet of Things (IoT) tag associated with an item of inventory.

25. The non-transitory computer-readable medium of claim 23, wherein the first subset includes one or more energizer devices configured to transmit energizing waveforms for powering electrical components of the ambient device.

26. The non-transitory computer-readable medium of claim 25, wherein the one or more energizer devices are configured to transmit the energizing waveforms according to a set of transmission parameters, and wherein the signal transmissions are made by the ambient device according to the set of transmission parameters.

27. The non-transitory computer-readable medium of claim 26, wherein the second subset includes at least one of an electronic shelf label (ESL) device or an access point, and wherein the positioning data includes measurements of the signal transmissions received by the second subset.

28. An electronic shelf label (ESL) system comprising:
a first subset of devices;
a second subset of devices; and
a server comprising a memory and at least one processor coupled to the memory, wherein the at least one processor is configured to perform operations comprising:
configuring, by the server, the first subset of devices to transmit energizing radio waves for an ambient device in a vicinity of the first subset;
receiving, by the server from the second subset of devices, positioning data relating to signal transmissions received by the second subset from the ambient device based on the energizing radio waves from the first subset;
comparing, by the server, the positioning data with ground truth data correlating devices with known locations;
identifying, by the server based on the comparing, at least one matching device for which the ground truth data matches the positioning data; and
determining, by the server, a position of the ambient device based on a corresponding known location of the at least one matching device.

29. The ESL system of claim 27, wherein the ambient device is an ambient Internet of Things (IoT) tag associated with an item of inventory.

30. The ESL system of claim 27, wherein the first subset includes one or more energizer devices configured to transmit energizing waveforms for powering electrical components of the ambient device, wherein the second subset includes at least one of an ESL device or an access point, and wherein the positioning data includes measurements of the signal transmissions received by the second subset.
